(19) United States
(12) Patent Application Publication
(10) Pub. No.: US 2009/0204484 A1
(43) Pub. Date: Aug. 13, 2009

(54) Method of Displaying Targeted Digital Electronic Advertising Using Global Positioning System (GPS) Coordinates and Associated Demographic Data

(76) Inventor: Grayson Johnson, Tampa, FL (US)

Correspondence Address: Grayson Johnson, 507 Georgetown Pl, Safety Harbor, FL, 34695, US

(21) Appl. No.: 12/027,321

(22) Filed: Feb. 7, 2008

(51) Int. Cl. G06Q 30/00

(52) U.S. Cl. 705/14

(57) ABSTRACT

This invention describes a system for displaying targeted digital electronic advertising on mobile display systems based upon GPS coordinates and demographic data correlated to those GPS coordinates and current time. The display can “intelligently” download and project relevant and targeted advertising based upon (1) the displays known location, (2) current time, and (3) demographic data of people known to share the display's location at that time. Displayed content can thereby change in a dynamic fashion and with relatively unlimited frequency. Advertising content and demographic data can be stored local to the display device (“onboard”) or obtained in real time using any number of wireless networking technologies as the display moves through space and time. Further, total display times of a given advertisement can be calculated and stored as means to determine advertising fees.

### FIELD OF THE INVENTION

The invention relates to a mobile display device which can determine, download, and display advertisement deemed most relevant to a given location based upon a correlation of the displays GPS coordinates and the demographic data of people known and anticipated to view the display device at that location and time.

### DESCRIPTION OF THE CURRENT ART

Many devices exist today which are mobile and capable of displaying electronic advertising. These devices will continue to proliferate with the advent of newer, lighter, and more cost effective display technologies such as organic light emitting diode (OLED) technology. It is likely that we will see complete vehicle “skins” with the ability to display information electronically and change relative to some external input or stimuli, with the objective of remaining fresh and relevant as the vehicle moves through space and time.

Some electronic display device systems today possess the capability to manually enter or determine their GPS coordinates and display advertising based upon those coordinates. However, these devices are limited in their ability to react and change the relevancy of the display advertising in relative real time as (1) their location changes, and (2) the known profile and consumption behavior of their potential audience changes with a change in the location of the display device changes and/or time.

### SUMMARY OF THE INVENTION

Therefore, it is the purpose of this invention to extend and provide greater utility, flexibility and “intelligence” to these display systems by introducing all of the following components to the system and extending its utility based upon the interrelationship of said components. It is the interrelationship and dependencies of the of the system components which is claimed to be unique.

Components:
1. Known GPS coordinates obtained from a local “onboard” GPS receiver.
2. Demographic and consumption profiles of the people most likely to occupy a given location at a given time obtained from either/or a remote or local (onboard) database of demographic data whose data is indexed to GPS location and time of day.
3. A database of digital electronic advertising.
4. The ability to correlate GPS coordinates and demographic data to a database of advertising for the purpose of correlating, selecting, streaming, and displaying the advertising deemed most relevant for that location at the time.
5. The ability to connect to remote databases using wireless networking technologies.
6. The ability to calculate and store the time and duration in which each advertisement was displayed for the purpose of determining advertising fees.

By means of a hypothetical example, a high definition organic light emitting diode (display device) is integrated into the side of a city bus. As that bus moves throughout a city the display device system will perform a look up of known demographic data associated with the system's location at that time. Then, based on both the GPS coordinates and the demographic data, the system will display the advertisement deemed most relevant to that location at that time. Therefore, as the bus moves in space and time and as the demographics of the potential audience are known to change, the advertising can be refreshed so as to remain relevant to the new location and time. A more detailed illustration follows:
The bus stops at the corner of a city block. The onboard display system takes a reading of its GPS coordinates and the current time. The system then performs a lookup to compare those coordinates to a database of available demographic data. This database lookup determines that the bus is stopped in front a popular coffee shop which is known to be heavily populated at that time of day by college educated males aged 20-28 with a purchasing proclivity for a particular brand of shaving razor. The display then streams and displays the most relevant and available advertising for that product while stopped in front of, or passing nearby, the coffee shop. As the bus pulls away and its location changes, the display will repeat this process in order that the displayed advertisement remain targeted and relevant to the anticipated audience as the bus's location changes in space and time. The ability to change and refresh the displayed advertising will be limited only by the granularity of the demographic data and the processing time of the onboard computers and the display itself. The time, location, and duration that each advertisement is displayed is simultaneously calculated and stored in a database, either local or remote to the system, to facilitate the future or real time billing of advertising fees.

### BRIEF DESCRIPTION OF THE DRAWINGS

FIG. 1: Block diagram depicting components of the invention and the general interrelationship among components.

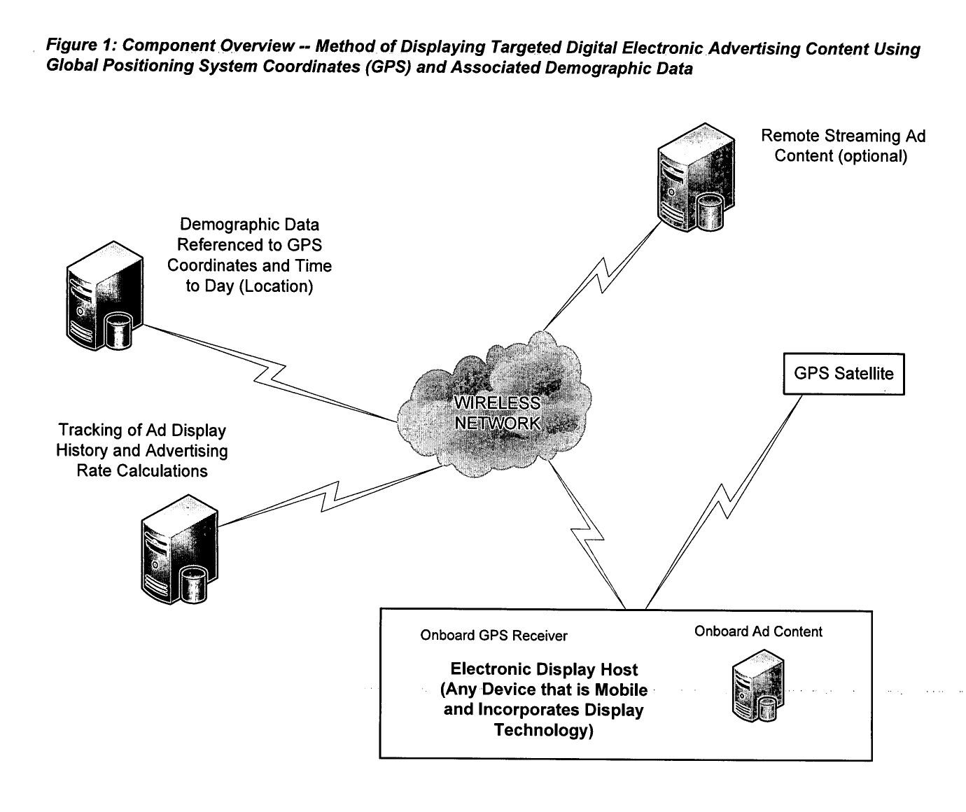

What is claimed:

1. A system which displays digital electronic advertising based upon:
a. the current GPS coordinates of the display system
b. the demographic profile and consumption tendencies of the people most likely to view the system's display device at its current location and time
c. the ability to correlate, choose, stream, and display the most relevant available advertising based upon the parameters of items a. and b.
d. the ability to calculate and record the total display time of a given advertisement for the purpose of determining advertising fees

2. A system according to claim 1, which includes any electronic device which is mobile and capable of displaying digital electronic advertising.

3. A system according to claim 1, which includes a manner of determining GPS coordinates. Specifically, location and time.

4. A system according to claim 1, which includes a device capable of accepting the GPS coordinate data and performing a look up to a database of demographic data indexed to location and time.

5. A system according to claim 1, which can connect to and communicate with one or more databases of stored electronic advertising media, demographic data, or any data useful to the objective, either directly or through the use of wireless networking technology.

6. A system according to claim 1, which can search available digital advertising media, select said data deemed to be most relevant to that location, time and demographics of the anticipated audience, load said data, and display said data.

7. A system according to claim 1, which can calculate and record total display time per advertisement for the purpose of calculating fees for displaying said advertisement.
